(19) United States
(12) Patent Application Publication
(10) Pub. No.: US 2026/0122117 A1
(43) Pub. Date: Apr. 30, 2026

(54) MANAGING A DYNAMIC AND MODULAR NOTIFICATION REGION DURING A VIDEO CONFERENCE

(71) Applicant: Google LLC, Mountain View, CA (US)

(72) Inventors: Kelly Dern, Boulder, CO (US); Justin Volz, Oakland, CA (US); Avery Fisher, San Francisco, CA (US); Kevin Kim, Washington, DC (US); Yanlin Ma, Brooklyn, NY (US); Yiwei Huang, Mountain View, CA (US); Adanma Ekeledo, Portland, OR (US)

(21) Appl. No.: 18/931,685

(22) Filed: Oct. 30, 2024

(51) Int. Cl. H04L 65/403; G06F 3/0482; G06F 3/0484

(52) U.S. Cl. CPC H04L 65/403; G06F 3/0482; G06F 3/0484

(57) ABSTRACT

A method includes providing, by a processor, for presentation during a virtual meeting, a virtual meeting user interface (UI) on a user device of a user participating in the virtual meeting. The user interface comprises a notification region. A notification pertaining to an action performed during the virtual meeting is detected and a notification type of the notification is determined based on a plurality of notification types each associated with one of a plurality of rule groups. One or more rules of a rule group associated with the determined notification type of the notification is identified. The one or more rules of the rule group define a unique set of display parameters associated with the notification region. During the virtual meeting, the notification region is caused to be modified to display a UI element associated with the notification according to the one or more rules of the rule group.

### TECHNICAL FIELD

Aspects and implementations of the present disclosure relate to managing a dynamic and modular notification region during a video conference.

### BACKGROUND

Video conferences can take place between multiple participants via a video conference platform. A video conference platform includes tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the video conference platform can provide a user interface that includes multiple regions to visually represent the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes providing, by a processor, for presentation during a virtual meeting, a virtual meeting user interface (UI) on a user device of a user participating in the virtual meeting. The user interface comprises a notification region. A notification pertaining to an action performed during the virtual meeting is detected and a notification type of the notification is determined based on a plurality of notification types each associated with one of a plurality of rule groups. One or more rules of a rule group associated with the determined notification type of the notification is identified. The one or more rules of the rule group define a unique set of display parameters associated with the notification region. During the virtual meeting, the notification region is caused to be modified to display a UI element associated with the notification according to the one or more rules of the rule group.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example virtual meeting user interface (UI) presented to a user of a client device during a video conference, in accordance with implementations of the present disclosure.

FIG. 3 illustrates a diagram showing the display locations of a set of rule groups in an example notification region (“peninsula”) of a virtual meeting UI, in accordance with implementations of the present disclosure.

FIG. 4 illustrates another example notification region (“peninsula”) of a virtual meeting UI, in accordance with implementations of the present disclosure.

FIGS. 5A-5C are illustrations of an example visual presentation of a participant badge being modified, in accordance with implementations of the present disclosure.

FIGS. 6A-6C are illustrations of an example visual presentation of a record badge being modified, in accordance with implementations of the present disclosure.

FIGS. 7A-7B are illustrations of an example visual presentation of a bridge feature, in accordance with some implementations of the present disclosure.

FIG. 8 is an illustration of an example visual presentation of a hover feature, in accordance with some implementations of the present disclosure.

FIG. 9 is an illustration of an example video conference user interface with a peninsula displaying the backpack feature, in accordance with some implementations of the present disclosure.

FIG. 10 depicts a flow diagram of a method for managing a notification region during a video conference, in accordance with implementations of the present disclosure.

FIG. 11 is a block diagram illustrating an exemplary computer system, in accordance with implementations of the present disclosure.

### DETAILED DESCRIPTION

Aspects of the present disclosure relate to managing a dynamic and modular notification region during a virtual meeting between users of a video conference platform. A video conference platform can enable virtual meetings, such as video-based conferences, between multiple participants via respective client devices that are connected over a network and share each other's audio (e.g., voice of a user recorded via a microphone of a client device) and/or video streams (e.g., a video captured by a camera of a client device) during a video conference. In some instances, a video conference platform can enable a significant number of client devices (e.g., up to one hundred or more client devices) to be connected via the video conference.

A participant of a video conference can speak (e.g., present on a topic) to the other participants of the video conference. Some existing video conference platforms can provide a user interface (UI) to each client device connected to the video conference, where the UI visually represents the video streams shared over the network in a set of regions in the UI. For example, the video stream of a participant who is speaking to the other participants in the video conference can be visually represented in a designated region in the UI of the video conference platform.

During the video conference, the UI can present the participants with various “snackbar” notifications. Snackbar notifications refer to notifications that can provide brief messages (e.g., banners, badges, overlays, etc.) about actions that were performed or will be performed. For example, these notifications can include alerts that a participant has joined or left the video conference, posted a message, raised their hand, generated a poll, etc.

In current video conference platforms, different notifications are presented in various sections of the UI. For example, a participant posting a message can be shown a popup from a chat section of the UI, a hand raised can be shown as a badge streaking across the UI, a participant joining can be shown as a banner at the top of the UI, and so forth. As such, these notifications are inconsistently presented to the participants, which can interrupt their focus and increase the cognitive burden they experience while attending the video conference. Further, presenting the different notifications in various sections of the UI can result in inefficient use of screen space and can increase the consumption of computing resources (e.g., processing, computational, and memory resources) used by the video conference system.

Aspects and implementations of the present disclosure address these and other shortcomings of the existing technology by providing and managing a dynamic and modular notification region, referred to herein as a “peninsula,” during a virtual meeting. In particular, the peninsula can be presented in a specific section of the UI, such as, for example, the top-left corner of the UI. The peninsula can display different badges for different notifications related to actions performed by the user of the virtual meeting, other participants of the virtual meeting, or by components (e.g., software or hardware) of the video conference platform. A badge can refer to a visual element (visual aid) that conveys specific information on the UI. Each new notification can trigger a morph (change) of the peninsula. The morph can relate to the peninsula expanding (thus adding one or more additional badges), contracting (hiding/removing one or more displayed badges), modifying the badges displayed, collapsing the two or more badges into a collapsible UI element, etc. The notifications can be related to recording the virtual meeting, enabling transcribing of the virtual meeting, participants entering and/or leaving the virtual meeting, participants performing specific operations (e.g., hand raise, generating a poll, posting a message, etc.), and so forth.

In some implementations, each type of notification can be associated with a specific group (e.g., primary group, secondary group, tertiary group, etc.), where each group can be assigned to a particular set of display rules. The display rules can determine in which section of the peninsula (referred to as a “display location”) a badge should be displayed, for how long a badge should be displayed, etc. For example, the display rules for the primary group can indicate that badges in this group should be permanently displayed in a first location of the peninsula, the display rules for the secondary group can indicate that badges in this group should be present only when their feature is active, and when two or more badges from the secondary group are present, they should be collapsed into a collapsible UI element (referred to as a “backpack”), and the display rules for the tertiary group can indicate that badges in this group, once active, should be displayed only for a predetermined time.

In some implementations, the backpack can contain multiple badges while only a subset of the badges in the backpack are displayed. This prevents the badges from covering an excessive amount of space on the UI. To access the un-displayed badges, a participant can hover over the backpack which will trigger an expansion of the backpack (e.g., a vertical display of the badges in the backpack). Once the backpack is expanded, the user can interact with each badge (e.g., select the badge for additional information, trigger a new UI element related to the badge, remove the badge from the backpack, etc.).

Aspects of the present disclosure result in technological advantages including improved performance of the virtual meeting interface and improved overall performance of the video conference platform. In particular, the aspects of the present disclosure enable additional functionality of a video conference platform by providing tools that organize notification related messages to improve user experience by helping virtual meeting participants maintain focus and reduce their cognitive burden. Additionally, the technology disclosed herein can result in efficient use of screen space by preventing different notifications from cluttering various sections of the UI and can reduce the consumption of computational, memory, and processing resources by uniformly using a designated area for notifications across UIs presented on client devices of virtual meeting participants.

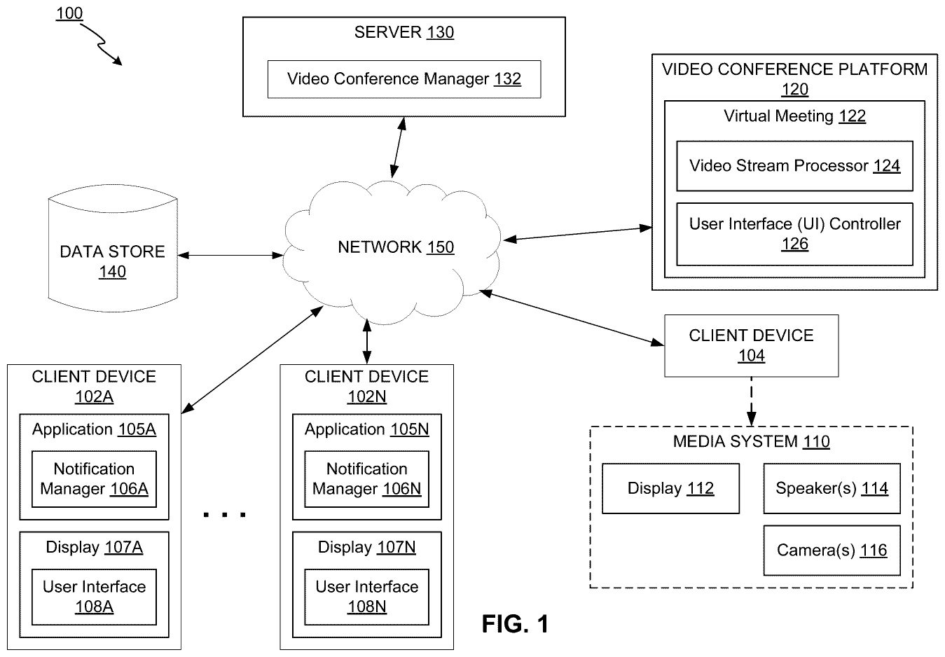

FIG. 1 illustrates an example system architecture 100, in accordance with implementations of the present disclosure. System architecture 100 (also referred to as “system” herein) includes client devices 102A-102N, one or more client devices 104, video conference platform 120, server 130, and data store 140, each connected to network 150.

In some implementations, network 150 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 140 is a persistent storage that is capable of storing data as well as data structures to tag, organize, and index the data. A data item can include audio data and/or video stream data, in accordance with implementations described herein. Data store 140 can be hosted by one or more storage devices, such as main memory, magnetic or optical storage-based disks, tapes or hard drives, NAS, SAN, and so forth. In some implementations, data store 140 can be a network-attached file server, while in other implementations data store 140 can be some other type of persistent storage such as an object-oriented database, a relational database, and so forth, that can be hosted by video conference platform 120 or one or more different machines (e.g., the server 130) coupled to the video conference platform 120 via network 150. In some implementations, data store 140 can store portions of audio and video streams received from the client devices 102A-102N for the video conference platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-102N and/or concurrently editable by the users.

Video conference platform 120 can enable users of client devices 102A-102N and/or client device(s) 104 to connect with each other via a virtual meeting (e.g., virtual meeting 122). A virtual meeting refers to a real-time communication session between multiple participants and may include a video conference, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. Video conference platform 120 can allow a user to join and participate in a virtual meeting call with other users of the platform. Implementations of the present disclosure can be implemented with any number of participants connecting via the virtual meeting (e.g., up to one hundred or more).

In some implementations, video conference manager 122 includes video stream processor 124 and user interface (UI) controller 126. Video stream processor 124 can receive video streams from the client devices (e.g., from client devices 102A-102N and/or 104). Video stream processor 124 can determine visual items for presentation in the UI (e.g., the UIs 108-108N) during a virtual meeting. Each visual item can correspond to a video stream from a client device (e.g., the video stream pertaining to one or more participants of the virtual meeting). In some implementations, the video stream processor 124 can receive audio streams associated with the video streams from the client devices (e.g., from an audiovisual component of the client devices 102A-102N). Once the video stream processor has determined visual items for presentation in the UI, the video stream processor 124 can notify the UI controller 126 of the determined visual items. The visual items for presentation can be determined based on current speaker, current presenter, order of the participants joining the virtual meeting, list of participants (e.g., alphabetical), etc.

UI controller 126 can provide the UI for a virtual meeting. The UI can include multiple regions. Each region can visually represent a video stream pertaining to one or more participant of the virtual meeting. UI controller 126 can control which video stream is to be represented by providing a command to the client devices that indicates which video stream is to be represented in which region of the UI (along with the received video and audio streams being provided to the client devices). For example, in response to being notified of the determined visual items for presentation in the UI 108A-108N, UI controller 126 can transmit a command causing each determined visual item to be displayed in a region of the UI and/or rearranged in the UI.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices.” Each client device 102A-102N can include an audiovisual component that can generate audio and video data to be streamed to video conference platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-102N. In some implementations, the audiovisual component can also include an image capture device (e.g., a camera) to capture images and generate video data (e.g., a video stream) of the captured data of the captured images.

In some implementations, video conference platform 120 is coupled, via network 150, with one or more client devices 104 that are each associated with a physical conference or meeting room. Client device(s) 104 can include or be coupled to a media system 110 that can comprise one or more display devices 112, one or more speakers 114 and one or more cameras 116. Display device 112 can be, for example, a smart display or a non-smart display (e.g., a display that is not itself configured to connect to network 150). Users that are physically present in the room can use media system 110 and/or their own devices (e.g., client devices 102A-102N) to participate in a virtual meeting, which can include other remote users. For example, the users in the room that participate in the virtual meeting can control the display 112 to show a slide presentation or watch slide presentations of other participants. Sound and/or camera control can similarly be performed. Similar to client devices 102A-102N, client device(s) 104 can generate audio and video data to be streamed to video conference platform 120 (e.g., using one or more microphones, speakers 114 and cameras 116).

Each client device 102A-102N or 104 can include client application 105A-N, which can be a mobile application, a desktop application, a web browser, etc. In some implementations, client application 105A-N can present, on a display device 107-107N of client device 102A-102N, a user interface (UI) (e.g., a UI of the UIs 108A-108N) for users to access video conference platform 120. For example, a user of client device 102A can join and participate in a virtual meeting via a UI 108A presented on the display device 107A by client application 105A. A user can also present a document to participants of the virtual meeting via each of the UIs 108A-108N. Each of the UIs 108A-108N can include multiple regions to present visual items corresponding to video streams of the client devices 102A-102N provided to the server 130 for the virtual meeting.

In some implementations, server 130 includes a video conference manager 132. Video conference manager 132 can be configured to manage a virtual meeting between multiple users of video conference platform 120. In some implementations, video conference manager 132 can provide (e.g., using UI controller 126) the UIs 108A-108N to each client device to enable users to watch and listen to each other during a virtual meeting. Video conference manager 132 can also collect and provide data associated with the virtual meeting to each participant of the virtual meeting. In some implementations, video conference manager 132 can provide the UIs 108A-108N for presentation by client application 105A-105N. For example, the UIs 108A-108N can be displayed on a display device 107A-107N by client application 105A-105N executing on the operating system of the client device 102A-102N or the client device 104. In some implementations, the video conference manager 132 can determine visual items for presentation in the UI 108A-108N during a virtual meeting. A visual item can refer to a UI element that occupies a particular region in the UI and is dedicated to presenting a video stream from a respective client device. Such a video stream can depict, for example, a user of the respective client device while the user is participating in the video conference (e.g., speaking, presenting, listening to other participants, watching other participants, etc., at particular moments during the video conference), a physical conference or meeting room (e.g., with one or more participants present), a document or media content (e.g., video content, one or more images, etc.) being presented during the video conference, etc.

In some implementations, application 105A-105N includes notification manager 106A-106N. Notification manager 106A-106N can provide a dynamic and modular notification region, referred to as a “peninsula,” for display on the video conference platform. Alternatively, notification manager 106 (or at least some of its components) is part of video conference manager 312. The peninsula can be displayed in a specific section of user interface 108A-N. For example, the peninsula can be displayed in the top-left corner of user interface 108A-N, the top-right corner of user interface 108A-N, the bottom-left corner of user interface 108A-N, the bottom-right corner of user interface 108A-N, etc.

Notification manager 106A-106N can cause display, in the peninsula, of different badges for different notifications related to actions performed by the user of the virtual meeting (e.g., initiating a recording of the virtual meeting, live-streaming the virtual meeting, etc.), other participants of the virtual meeting (e.g., raising a hand during the virtual meeting, posting a comment during the virtual meeting, etc.), or by components the video conference platform (e.g., auto-transcribing the virtual meeting, admitting a new participant to the virtual meeting, etc.). A badge can refer to a UI element used as a visual aid to convey specific information (e.g., the type of action that was performed) on user interface 108A-108N. Each notification and/or action can be correlated to a particular badge. When an action is initiated, notification manager 106A-106N can generate a notification by triggering a morph (change) of the peninsula to display one or more corresponding badges (or modifying one or more already displayed badges) in the peninsula. The morph can relate to notification manager 106A-106N changing at least one dimension of the peninsula to display the badge, changing a shape of the peninsula to display the badge, changing a visual presentation of the peninsula to display the badge, etc. For example, notification manager 106A-106N can expand the peninsula to add one or more additional badges, contract the peninsula to remove one or more displayed badges, modifying the badges displayed in the peninsula, collapse two or more badges into collapsible UI element (referred to as a “backpack”), etc. The notifications and/or actions can be related to recording the virtual meeting, enabling transcribing of the virtual meeting, participants entering and/or leaving the virtual meeting, participants performing specific operations (e.g., hand raise, generating a poll, posting a message, etc.), and so forth. Further details with respect to the peninsula are described below.

As described previously, an audiovisual component of each client device can capture images and generate video data (e.g., a video stream) of the captured data of the captured images. In some implementations, the client devices 102A-102N and/or client device(s) 104 can transmit the generated video stream to video conference manager 132. The audiovisual component of each client device can also capture an audio signal representing speech of a user and generate audio data (e.g., an audio file or audio stream) based on the captured audio signal. In some implementations, the client devices 102A-102N and/or client device(s) 104 can transmit the generated audio data to video conference manager 132.

In some implementations, video conference platform 120 and/or server 130 can be one or more computing devices computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting. Video conference platform 120 can also include a website (e.g., a webpage) or application back-end software that can be used to enable a user to connect with other users via the virtual meeting.

It should be noted that in some other implementations, the functions of server 130 and/or video conference platform 120 can be provided by a fewer number of machines. For example, in some implementations, server 130 can be integrated into a single machine, while in other implementations, server 130 can be integrated into multiple machines. In addition, in some implementations, server 130 can be integrated into video conference platform 120.

In general, functions described in implementations as being performed by video conference platform 120 and/or server 130 can also be performed by the client devices 102A-N and/or client device(s) 104 in other implementations, if appropriate. In addition, the functionality attributed to a particular component can be performed by different or multiple components operating together. In some implementations, at least some of the functions of video conference manager 132, video stream processor 124 and/or UI controller 126 can be performed by one or more of client devices 102A-N and/or client device(s) 104. Further, in some implementations, the functions of notification manager 106A-106N can be performed by server 130 and/or by video conference platform 120. Video conference platform 120 and/or server 130 can also be accessed as a service provided to other systems or devices through appropriate application programming interfaces, and thus is not limited to use in websites.

Although some implementations of the disclosure are discussed in terms of video conference platform 120 and users of video conference platform 120 participating in a video conference, implementations can also be generally applied to any type of telephone call, conference call, or virtual meeting between users. Implementations of the disclosure are not limited to video conference platforms that provide video conference tools to users.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel, of the video conference platform 120.

In situations in which the systems discussed here collect personal information about users, or can make use of personal information, the users can be provided with an opportunity to control whether video conference platform 120 collects user information (e.g., information about a user's social network, social actions or activities, profession, a user's preferences, or a user's current location), or to control whether and/or how to receive content from the server 130 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the video conference platform 120 and/or server 130.

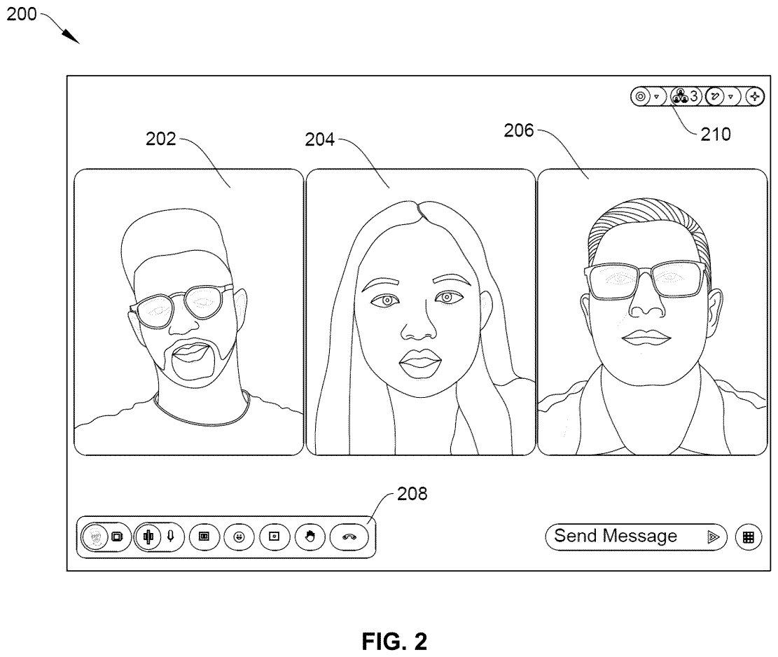

FIG. 2 illustrates an example virtual meeting UI 200 presented to a user of a client device during a video conference, in accordance with some implementations of the present disclosure. UI 200 can be generated by the video conference manager 132 of FIG. 1 for presentation at a client device (e.g., client devices 102A-102N, 104). Accordingly, UI 200 can be generated by one or more processing devices of the server 130 of FIG. 1. Alternatively, some or all portions of the UI 200 can be generated by one or more processing devices of one or more of client devices 102A-102N, 104. As illustrated, UI 200 provides, for presentation to one or more users, a visual item 202 corresponding to a video stream generated by a first client device of a first participant, a visual item 204 corresponding to a video stream generated by a second client device of a second participant from, and a visual item 206 corresponding to a video stream generated by a third client device of a third participant. The first participant can be, for example, the user of the client device displaying UI 200. UI 200 can include tool panel 208, which can include a set of buttons to perform one or more actions related to the video conference. The set of buttons can include, for example, a button to toggle the video feed (e.g., turn the video feed on/off, select a background, etc.), a button to toggle the audio feed (e.g., a mute button, a volume control button, an audio feed source button, etc.), a closed captions button (e.g., to turn on/off the closed captions during the video conference), a emoji button (e.g., to select one or more emojis for display), a presentation button (e.g., to allow a user to present during the video conference), a hand raise button, a leave button (e.g., a button to leave the video conference, to end the video conference, etc.), and so forth. UI 200 can further include peninsula 210, which can display the one or more badges that are used to convey, for example, one or more types of actions that were performed during the video conference, one or more features that are active during the video conference, etc. In some implementations, the peninsula 210 can consist of multiple display locations, where each display location is assigned to display a specific set of badges using, for example, a specific set of display rules.

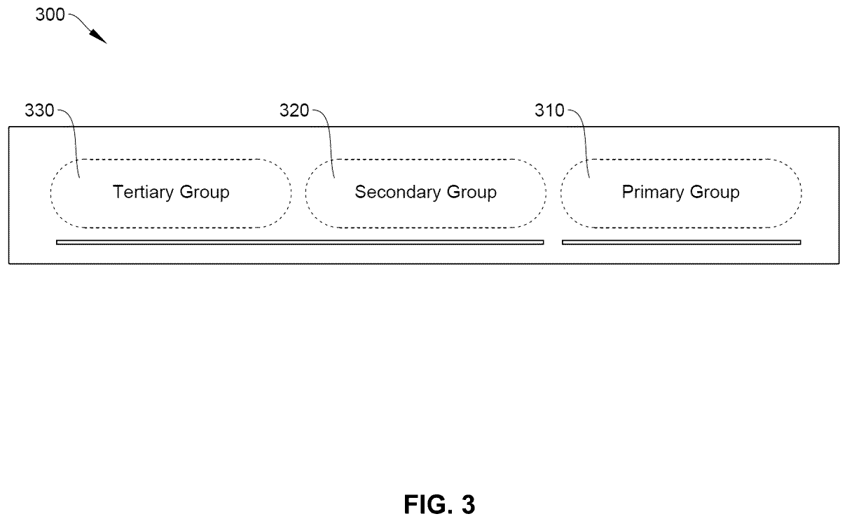

FIG. 3 illustrates a diagram 300 showing the display locations of a set of rule groups in a notification region (“peninsula”) of a virtual meeting UI, in accordance with some implementations of the present disclosure. In particular, the peninsula includes three display locations for displaying badges assigned to particular rule groups. More specifically, display location 310 can be configured to display badges assigned to a “primary” group, display location 320 can be configured to display badges assigned to a “secondary” group, and display location 330 can be configured to display badges assigned to a “tertiary” group. Each display location and/or group can be assigned a specific set of display rules.

By way of illustrative example, badges assigned to the primary group can be thought of as core badges that should be present and accessible throughout the video conference. As such, the display rules assigned to the primary group can request that assigned badges be always displayed (e.g., persistent) in a virtual meeting UI, that assigned badges stack (e.g., horizontally stack, vertically stack) and be not combined into a collapsible UI element (e.g., an overflow container referred to as a “backpack”), etc. By way of illustrative example, primary group badges can include participants badges (badge showing the participates of the video conference), hand raise badges, an artificial intelligence chatbot badge (a selectable badge that can open the chatbot), a badge indicative of conference notes being generated, a badge indicative of the number of viewers observing the video conference, a badge indicative of the number of viewers observing the video conference, etc.

Badges assigned to the secondary group can be displayed only when activated, and can remain displayed for the entire duration of the video conference, for a (relatively) long time once activated, etc. Badges assigned to the secondary group can collapse into the backpack in response to a threshold number of secondary groups badges being displayed and/or a timer related to a displayed secondary group badge lapsing. By way of illustrative example, secondary group badges can include a badge indicative of the video conference being live streamed, a badge indicative of the video conference being recorded and/or being transcribed, a badge indicative of the video conference being encrypted, etc.

Badges assigned to the tertiary group can be displayed when their feature is activated, and can remain displayed for a predetermined (relatively short) duration, until a user interacts with the badge, etc. By way of illustrative example, tertiary group badges can include a badge indicative of an active poll, an active timer, an active breakout room, etc. It should be understood that any number of display locations and/or groups can be used, each having a set of assigned badges and/or set of rules. It should be further understood that certain badges and/or display rules can be assigned to multiple display locations.

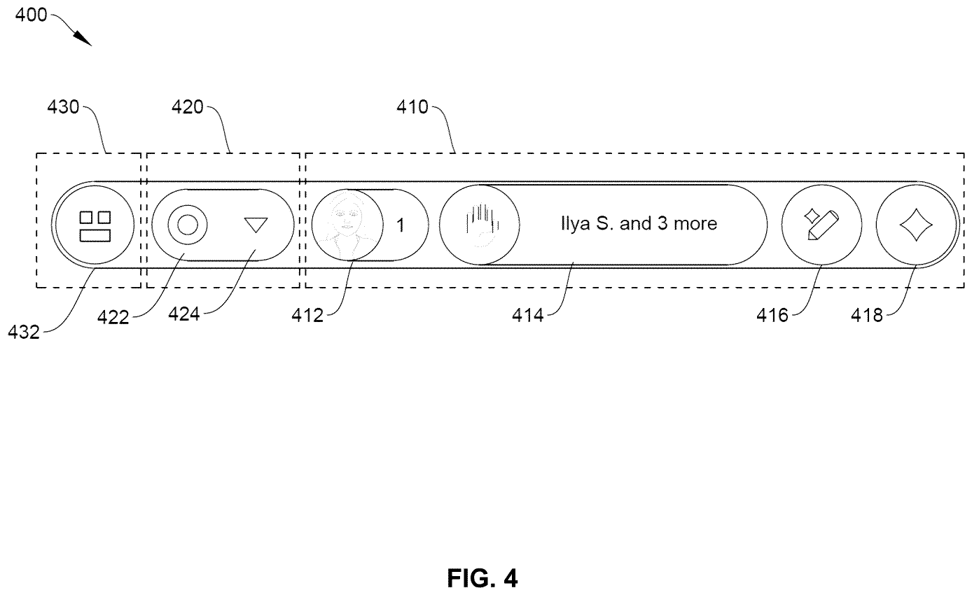

FIG. 4 illustrates another example peninsula 400 of a virtual meeting UI, in accordance with some implementations of the present disclosure. In particular, peninsula 400 includes display location 410 configured to display primary group badges, display location 420 configured to display secondary group badges, and display location 430 configured to display tertiary group badges, where each display location is configured to display badges according to a set of rules. Display location 410 includes a participants badge 412, a hand raise badge 414, a notes badge 416 (a badge indicative of conference notes being generated), and an artificial intelligence chatbot badge 418. Display location 420 includes a recording badge 422 and a backpack dropdown button 424. Display location 430 includes a breakout rooms badge 432.

In some implementations, the set of rules can include an order of appearance for each badge assigned to a particular group (or display location). The order of appearance can indicate where in the display location each assigned badge is displayed when two or more badges are displayed. In the illustrative example shown by FIG. 4, the order of appearance can indicate that the participants badge 412 is to be displayed in the first position (e.g., the leftmost section) of the first display location, the hand raise badge 414 is to be displayed in the second position (e.g., to the right of the participants badge, the transcribe badge 416 is to be displayed in the third position (e.g., to the right of the hand raise badges), and the chatbot badge 418 is to be displayed in the fourth position (e.g., to the right of the transcribed badge).

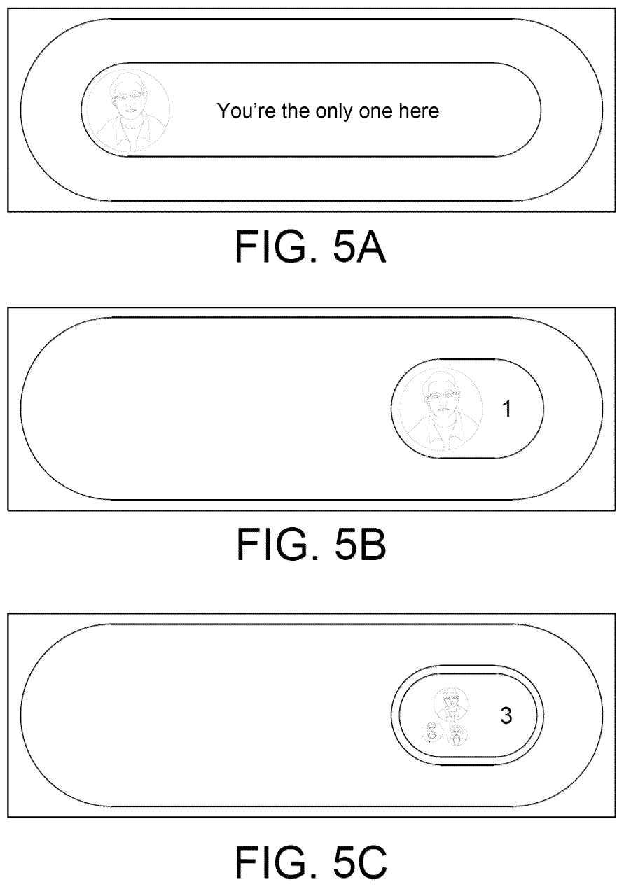

In some implementations, notification manager 106A-106N can cause the visual presentation of certain badges to be modified. For example, notification manager 106A-106N can cause a badge to be expanded or collapsed, the display of a badge to be changed, a badge to shrink or to be enlarged, etc. These modifications can be triggered by, for example, the expiration of a time, a new action being performed, etc. FIGS. 5A-5C are illustrations of an example visual presentation of a participant badge being modified in a virtual meeting UI, in accordance with implementations of the present disclosure. In particular, in response to a user initiating a video conference, a participant badge can be generated showing the participant. As shown in FIG. 5A, the participants badge can be expanded and show a picture of the user as well as a message stating that the user is the only participant in the video conference. As shown in FIG. 5B, after the expiration of a timer, the participants badge can collapse into a smaller version of the badge where the participant's picture is shown along with the number of participants on the video conference (e.g., 1 participant). FIG. 5C shows that in response to two additional participants joining the video conference, the participants badge is modified to show the picture of each participant along with the total number of participants (e.g., 3) on the video conference.

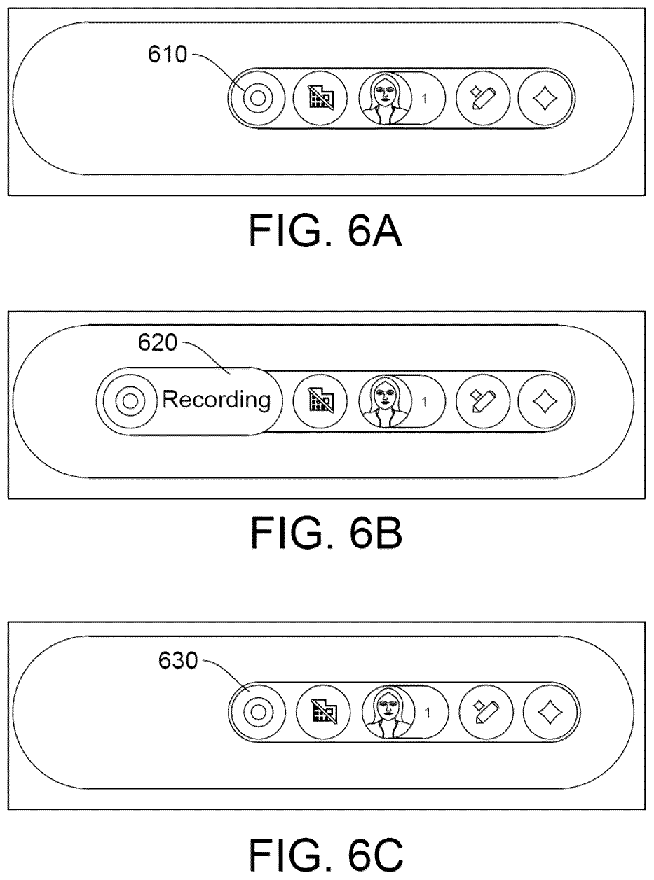

FIGS. 6A-6C are illustrations of an example visual presentation of a record badge being modified in a virtual meeting UI, in accordance with some implementations of the present disclosure. In particular, as shown in FIG. 6A, in response to a user initiating (enabling) the recording function during the video conference, a record badge 610 can be displayed in the peninsula. As shown in FIG. 6B, the record badge 620 can then be expanded (e.g., expand to the left) to include the text “recording” next to the record icon. As shown in FIG. 6C, in response to a user disabling the record function, record badge 630 can collapse into a smaller version of the badge and change color, brightness or similar visual characteristic to indicate that the recording function is disabled. In some implementations, the record button can then, upon the expiration of a timer, be collapsed into a backpack or be removed from the peninsula.

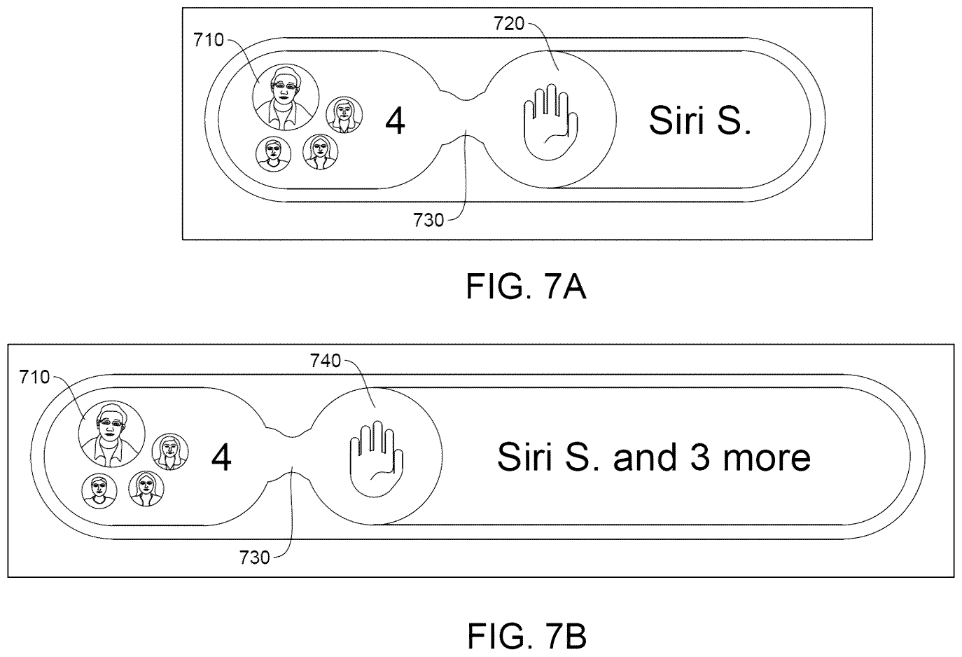

FIGS. 7A-7B are illustrations of an example visual presentation of a bridge feature in a virtual meeting UI, in accordance with some implementations of the present disclosure. In particular, one or more display rules can indicate that certain badges have a parent-child relationship. Once a child badge is generated for display (e.g., based on an action by a participant), the parent badge and child badge can be displayed with a visual connection (referred to as a “bridge”) between the two badges. For example, as shown in FIG. 7A, the parent badge 710 can include a participant badge showing four participants and the child badge 720 can include a hand raised badge that indicates the name of the participant that raise their hand. The parent badge 710 and the child badge 720 can be displayed as visually connected by bridge 730. FIG. 7B shows that as additional participants raise their hands, the child badge 740 can be modified to display how many participants raise their hands.

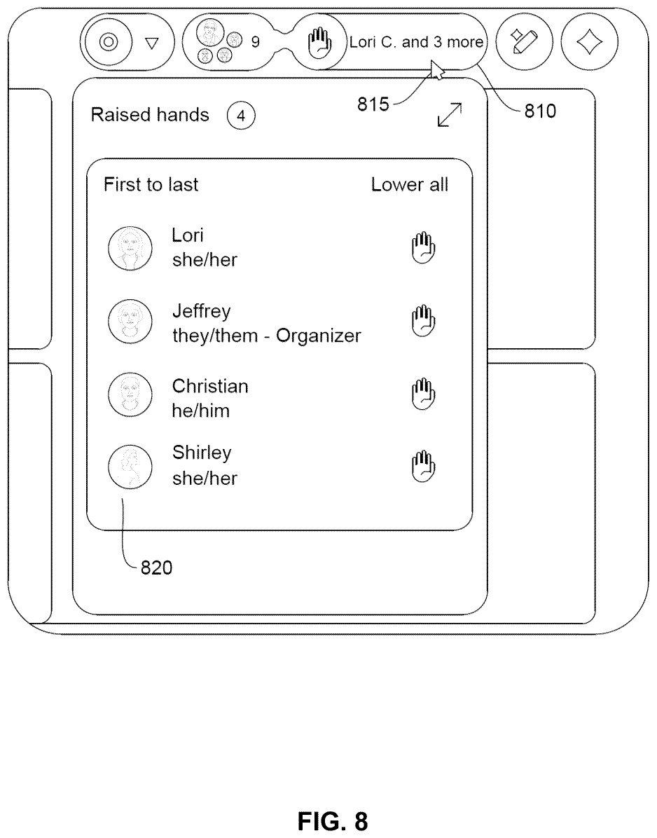

FIG. 8 is an illustration of an example visual presentation of a hover feature in a virtual meeting UI, in accordance with some implementations of the present disclosure. In particular, one or more display rules can indicate that certain badges can generate an additional UI in response to detecting a graphical control trigger. The graphical control trigger can include a user interacting with the particular badge, such as, for example, hovering over the badge with a cursor, selecting the badge with a cursor, etc. For example, as shown in FIG. 8, the raised hand badge 810 indicates that four participants raised their hands. In response to cursor 815 hovering over badge 810, UI 820 is displayed which shows each participant that raised their hand. The user can then interact with UI 820 by, for example, selecting a raise hand, lowering all the raised hands, etc.

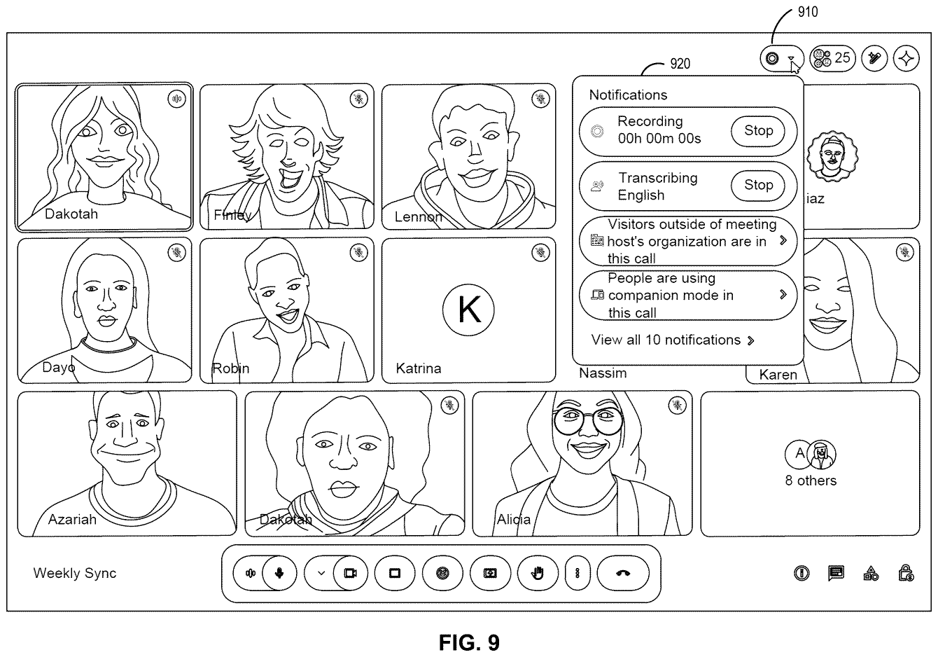

FIG. 9 is an illustration of an example virtual meeting UI with a peninsula displaying the backpack feature, in accordance with some implementations of the present disclosure. In particular, one or more display rules can indicate that once a certain number of badges are displayed within a particular group or display location, a subset of these badges can be collapsed into a backpack. In some implementations, one or more badges can remain visible in the display location while the rest are collapsed into the backpack. The backpack can be a UI element that includes collapsed badges and is expanded via, for example, a dropdown button. Once the backpack is selected (e.g., via a graphical control trigger such as interacting with the backpack via a cursor), a secondary UI element can be displayed to allow the user to interact with the badges placed into the backpack. For example, as shown in FIG. 9, display location 910 shows a record badge and a cursor hovering over the dropdown button for the backpack. Backpack 920 includes four badges, a record button, a transcribe button, and two alert buttons indicating that outside visitors are on the call and participants are using companion mode. The user can, via the cursor, interact with each badge by, for example, disabling the functions related to the respective badges. For example, the user can stop recording, stop transcribing, stop the encryption operations, etc.

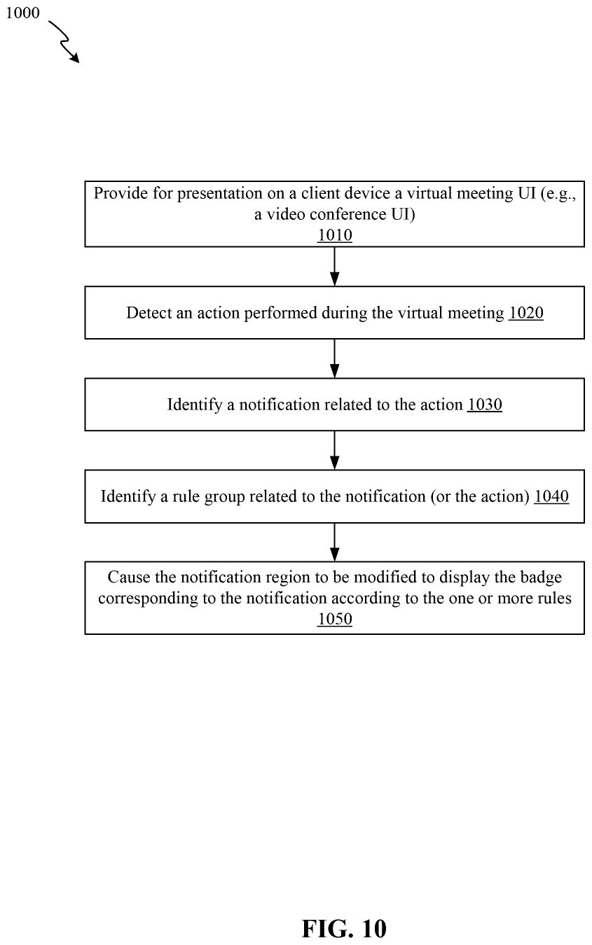

FIG. 10 depicts a flow diagram of a method 1000 for modifying a peninsula during a video conference, in accordance with implementations of the present disclosure. Method 1000 can be performed by processing logic that can include hardware (circuitry, dedicated logic, etc.), software (e.g., instructions run on a processing device), or a combination thereof. In some implementations, some or all the operations of method 1000 can be performed by notification manager 106A-106N and/or one or more other components of system 100 of FIG. 1 (e.g., client device 102A-102N, video conference platform 120, and/or server 130).

For simplicity of explanation, the method 1000 of this disclosure is depicted and described as a series of acts. However, acts in accordance with this disclosure can occur in various orders and/or concurrently, and with other acts not presented and described herein. Furthermore, not all illustrated acts can be required to implement the method 1000 in accordance with the disclosed subject matter. In addition, those skilled in the art will understand and appreciate that the method 1000 could alternatively be represented as a series of interrelated states via a state diagram or events. Additionally, it should be appreciated that the method 1000 disclosed in this specification is capable of being stored on an article of manufacture (e.g., a computer program accessible from any computer-readable device or storage media) to facilitate transporting and transferring such a method to computing devices. The term “article of manufacture,” as used herein, is intended to encompass a computer program accessible from any computer-readable device or storage media.

At operation 1010, processing logic provides for presentation on a client device a virtual meeting UI (e.g., a video conference UI), which can be generated, for example, by a video conference client application and presented in a UI provided by the video conference application or generated by a server of a video conference platform and presented via a web browser. In some implementations, the client device can be client device 102A-102N, 104 and the video conference application can be application 105A-N. In some implementations, the virtual meeting UI can be presented in response to the user's request (e.g., by selecting a link or button) to join the virtual meeting. For example, the user can receive a notification (e.g., a pop-up window) indicating that a video conference has begun or is scheduled to begin at a certain time. Responsive to the user selecting a button to access the video conference, processing logic can open the video conference application or a browser window and present the video conference UI.

The virtual meeting UI can include a notification region (e.g., a peninsula) in a specific section of the UI, such as, for example, the top-left corner of the UI. The notification region (also referred herein as a peninsula) can include one or more display locations where each display location is assigned to display a specific set of UI elements (e.g., badges) using, for example, a specific set of display rules.

At operation 1020, processing logic detects an action performed during the virtual meeting. The action can be performed by the user of the virtual meeting, other participants of the virtual meeting, or by one or more components of the video conference platform.

At operation 1030, processing logic identifies a notification related to the action. The processing logic can also identify a badge corresponding to the notification and/or to the action.

At operation 1040, processing logic identifies a rule group related to the notification (or the action). In particular, the processing logic can maintain a set of rule groups where each notification (and corresponding badge) can be assigned to one or more rule groups. The rules of each rule group can indicate where a particular badge is displayed within the notification region, the type of visual presentations that are related to the badge, the duration the badge is displayed, etc.

At operation 1050, processing logic causes the notification region to be modified to display the badge corresponding to the notification according to the one or more rules. In particular, the processing logic can cause the notification region to be expanded (thus adding one or more additional badges), contracted (by removing one or more displayed badges), one or more displayed badges to be modified, the two or more badges to collapse into collapsible UI element (e.g., a backpack), etc. In some implementations, in response to a predetermined condition (e.g., the expiration of a timer), the processing logic can cause further modifications to the notification region.

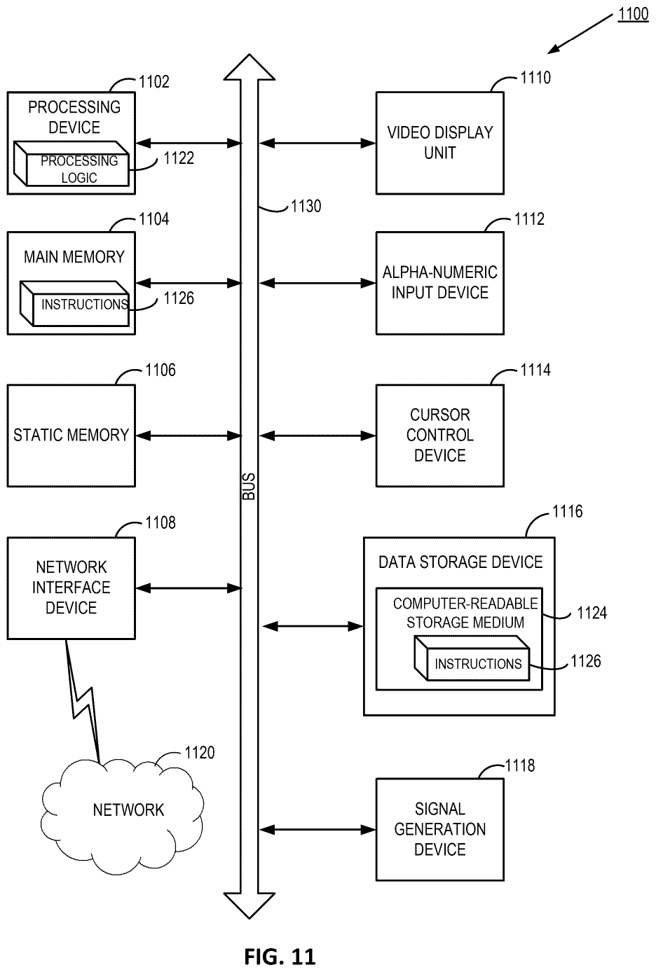

FIG. 11 is a block diagram illustrating an exemplary computer system, in accordance with implementations of the present disclosure. The computer system 1100 can be the server 130 or client devices 102A-N in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processing device (processor) 1102, a main memory 1104 (e.g., read-only memory (ROM), flash memory, dynamic random access memory (DRAM) such as synchronous DRAM (SDRAM), double data rate (DDR SDRAM), or DRAM (RDRAM), etc.), a static memory 1106 (e.g., flash memory, static random access memory (SRAM), etc.), and a data storage device 1116, which communicate with each other via a bus 1130.

Processing device 1102 represents one or more general-purpose processing devices such as a microprocessor, central processing unit, or the like. More particularly, processing device 1102 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1102 can also be one or more special-purpose processing devices such as an application specific integrated circuit (ASIC), a field programmable gate array (FPGA), a digital signal processor (DSP), network processor, or the like. Processing device 1102 is configured to execute processing logic 1122 (e.g., for determining a best-frame position and generating deviation alerts) for performing the operations discussed herein.

The computer system 1100 can further include a network interface device 1108. The computer system 1100 also can include a video display unit 1110 (e.g., a liquid crystal display (LCD) or a cathode ray tube (CRT)), an input device 1112 (e.g., a keyboard, and alphanumeric keyboard, a motion sensing input device, touch screen), a cursor control device 1114 (e.g., a mouse), and a signal generation device 1118 (e.g., a speaker).

The data storage device 1116 can include a non-transitory machine-readable storage medium 1124 (also computer-readable storage medium) on which is stored one or more sets of instructions 1126 (e.g., for determining a best-frame position and generating deviation alerts) embodying any one or more of the methodologies or functions described herein. The instructions can also reside, completely or at least partially, within the main memory 1104 and/or within processing device 1102 during execution thereof by the computer system 1100, the main memory 1104 and the processing device 1102 also constituting machine-readable storage media. The instructions can further be transmitted or received over a network 1130 via the network interface device 1108.

In one implementation, the instructions 1126 include instructions for determining visual items for presentation in a user interface of a video conference. While the computer-readable storage medium 1124 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
providing, by a processor, for presentation during a virtual meeting, a virtual meeting user interface (UI) on a user device of a user participating in the virtual meeting, wherein the user interface comprises a notification region;
detecting a notification pertaining to an action performed during the virtual meeting;
determining a notification type of the notification based on a plurality of notification types each associated with one of a plurality of rule groups;
identifying one or more rules of a rule group associated with the determined notification type of the notification, wherein the one or more rules of the rule group define a unique set of display parameters associated with the notification region; and
causing, during the virtual meeting, the notification region to be modified to display a UI element associated with the notification according to the one or more rules of the rule group.

2. The method of claim 1, wherein causing the notification region to be modified comprises causing at least one dimension of the notification region to be changed to display the UI element.

3. The method of claim 1, wherein causing the notification region to be modified comprises causing a visual presentation of the notification region to be changed to display the UI element.

4. The method of claim 1, further comprising:
responsive to an expiration of a timer, causing the UI element and another UI element to be contracted into an expandable UI element within the notification region.

5. The method of claim 4, further comprising:
causing the expandable UI element to be expanded in response to detecting a graphical control trigger associated with the expandable UI element.

6. The method of claim 1, wherein the one or more rules of the rule group indicate a duration to display the UI element.

7. The method of claim 1, wherein the one or more rules of the rule group indicate a location within the notification region to display the UI element.

8. The method of claim 7, wherein each rule group of the plurality of rule groups is associated with a predetermined display location within the notification region.

9. A system comprising:
a memory device; and
a processing device coupled to the memory device, the processing device to perform operations comprising:
providing for presentation during a virtual meeting, a virtual meeting user interface (UI) on a user device of a user participating in the virtual meeting, wherein the user interface comprises a notification region;
detecting a notification pertaining to an action performed during the virtual meeting;
determining a notification type of the notification based on a plurality of notification types each associated with one of a plurality of rule groups;
identifying one or more rules of a rule group associated with the determined notification type of the notification, wherein the one or more rules of the rule group define a unique set of display parameters associated with the notification region; and
causing, during the virtual meeting, the notification region to be modified to display a UI element associated with the notification according to the one or more rules of the rule group.

10. The system of claim 9, wherein causing the notification region to be modified comprises causing at least one dimension of the notification region to be changed to display the UI element.

11. The system of claim 9, wherein causing the notification region to be modified comprises causing a visual presentation of the notification region to be changed to display the UI element.

12. The system of claim 9, wherein the operations further comprise:
responsive to an expiration of a timer, causing the UI element and another UI element to be contracted into an expandable UI element within the notification region.

13. The system of claim 9, wherein the operations further comprise:
causing the expandable UI element to be expanded in response to detecting a graphical control trigger associated with the expandable UI element.

14. The system of claim 9, wherein the one or more rules of the rule group indicate a duration to display the UI element.

15. The system of claim 9, wherein the one or more rules of the rule group indicate a location within the notification region to display the UI element.

16. The system of claim 9, wherein each rule group of the plurality of rule groups is associated with a predetermined display location within the notification region.

17. A non-transitory computer readable storage medium comprising instructions for a server that, when executed by a processing device, cause the processing device to perform operations comprising:
providing for presentation during a virtual meeting, a virtual meeting user interface (UI) on a user device of a user participating in the virtual meeting, wherein the user interface comprises a notification region;
detecting a notification pertaining to an action performed during the virtual meeting;
determining a notification type of the notification based on a plurality of notification types each associated with one of a plurality of rule groups;
identifying one or more rules of a rule group associated with the determined notification type of the notification, wherein the one or more rules of the rule group define a unique set of display parameters associated with the notification region; and
causing, during the virtual meeting, the notification region to be modified to display a UI element associated with the notification according to the one or more rules of the rule group.

18. The non-transitory computer readable storage medium of claim 17, wherein causing the notification region to be modified comprises causing at least one dimension of the notification region to be changed to display the UI element t.

19. The non-transitory computer readable storage medium of claim 17, wherein causing the notification region to be modified comprises causing a visual presentation of the notification region to be changed to display the UI element.

20. The non-transitory computer readable storage medium of claim 17, wherein the operations further comprise:
responsive to an expiration of a timer, causing the UI element and another UI element to be contracted into an expandable UI element within the notification region.
